(19) United States
(12) Patent Application Publication
(10) Pub. No.: US 2007/0193094 A1
(43) Pub. Date: Aug. 23, 2007

(54) Device for attachment to a garment

(76) Inventor: Osman Noor, Hamilton (CA)

Correspondence Address: LANG MICHENER LLP, BCE PLACE, SUITE 2500, 181 BAY STREET, TORONTO, ON, M5J 2T7, CA

(21) Appl. No.: 11/356,991

(22) Filed: Feb. 21, 2006

(51) Int. Cl. G09F 3/18

(52) U.S. Cl. 40/661.04

(57) ABSTRACT

Among other things, the present invention provides a device for attachment to a garment. A base member of the device has a planar top surface portion which is slidably engagable with a planar bottom surface of a support frame, upon parallel movement of the base member in a first slide direction relative to the support frame. An internal chamber is defined within the support frame and a display panel is slidably insertable into same through one or more edge openings. Retainment means retain the top surface portion and bottom surface portion in intimate contacted relation with each other during the parallel movement. Cooperating portions of a catchment means engage each other to hold the support frame against parallel movement opposite the first slide direction once a display configuration is reached. An attachment means removably secures the device to the garment.

### FIELD OF THE INVENTION

The present invention relates to a device for attachment to a garment, and more particularly, to such a device having a selectively removable display panel.

### BACKGROUND OF THE INVENTION

Consumers continually desire to co-ordinate fashion accessories with clothing, in tune with rapidly changing trends in the fashion industry. One type of conventional accessory is jewelry, which comprises devices that are attached to garments worn by an individual, such as pins and brooches, in a variety of styles, colours and materials. Many of such devices such as, for example, cuff or hem links, often also serve to retain, in various configurations, the cuffs or hems of different garments. Many devices for attachment to garments have been developed, such as, for example, pins that may be attached to a garment that include a face having decorative indicia, and devices with ornamental sheet materials detachably secured to the face of an item of jewelry. Other jewelry items or devices may allow for interchangeable ornamentation such as, for example, by detachably securing a decorative plate or ornamental face member that snaps onto a pin base.

These items are limited in their use as they are typically produced in a fixed form, thereby failing to offer alternate ornamental appearances of a single device. Moreover, prior art devices are limited with respect to the ease of interchangability of different display panels. Common problems include an inability to sufficiently protect these display panels from various elements, such as normal wear and tear, or weather conditions, such as, for example, exposure to excessive sunlight, rain or snow. Furthermore, prior art devices are limited in terms of the range of display panels capable of being displayed by, or on, such devices in a manner so as to avoid damage during such display. As such, these prior art devices tend to be restricted in terms of the types of display panels that they are capable of displaying. Prior art devices are further restricted with respect to the ease of removal of, or change between, different display panels. More specifically, such removal or change may require a user to first remove substantially the entire device from the garment to which it is attached, thereby adding steps which are, strictly speaking, unnecessary in order to change display panels.

Accordingly, there exists an ongoing need for a device for attachment to a garment that is capable of exhibiting a desired display panel which can be readily removed and/or interchanged with other display panels, with or without removing the entire device from the garment. Such a device would also be adapted to protect any such exhibited display panel from external forces and/or adverse weather conditions and would further be adapted to retain, in various positions, the cuffs and/or hems of different types of garments. The present invention addresses these and other shortcomings of the prior art by providing a device for attachment to a garment with a selectively removable display panel that can be easily substituted by the consumer with other such display panels, with or without removing the entire device from the garment to which it is attached. The device of the present invention is further capable of retaining, or merely being attached to, the cuffs and hems of various garments, thereby representing a significant improvement over known prior art devices.

### SUMMARY OF THE INVENTION

In accordance with the foregoing, it is thus one object of the present invention to provide improvements in devices for attachment to garments having interchangeable display panels.

It is a further object of the present invention to provide a device for attachment to a garment wherein selection of the particular display panel is fully within the discretion of a user.

It is a further object of the present invention to provide a device for attachment to a garment that protects a display panel from exposure to external forces and/or weather conditions.

It is a further object of the present invention to provide an improved means for removably securing the display panel within a device for attachment to a garment.

It is a further object of the present invention to provide a device for attachment to a garment that allows a user to change the display panel with or without having to detach the device from the garment.

It is a still yet further object of the present invention to provide a device for attachment to a garment that is adapted to retain, in various positions, the cuffs or hems of different types of garments.

Accordingly, amongst other things, the present invention provides a device for attachment to a garment. The device comprises a base member having a substantially planar top surface portion and a bottom surface portion. The device further comprises a support frame having a substantially planar bottom surface portion. The substantially planar bottom surface portion is slidably engagable with the top surface portion of the base member upon parallel movement of the support frame relative to the base member, in a first slide direction, from an entry configuration, wherein planar top surface portion is partially overlain by the planar bottom surface portion, to a display configuration, wherein the planar top surface portion is substantially fully overlain by the planar bottom surface portion. The device further comprises one or more retainment means, mounted on the base member, for cooperation with the support frame to retain the top surface portion of the base member and the bottom surface of the support frame in intimate contacted relation with one another during the parallel movement in the first slide direction. The device further comprises a catchment means having cooperating portions mounted on each of the retainment means and the support frame to engage one another at the display configuration to hold the support frame against parallel movement in a second slide direction, which is opposite to the first slide direction. The device further comprises an attachment means, affixed to the bottom surface portion of the base member, for removably securing the device to the garment.

The support frame of the device comprises a top wall, a bottom wall and one or more side walls that together define an internal chamber. One or more edge openings provide access to the internal chamber. The device further comprises a display panel that is slidably insertable into the internal chamber through the one or more edge openings.

The display panel has a presentation face with decorative indicia marked thereon. The presentation face is upwardly directed so as to be visible through the top wall of the support frame when the display panel is fully inserted into the internal chamber. The top wall of the support frame is substantially transparent.

The device further comprises a stop means, mounted atop the base member, adjacent a third edge thereof and in substantially transverse relation to the track members. The stop means is adapted so as to be contactable with the support frame at the display configuration so as to limit further parallel movement thereof, in the first slide direction

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a top plan view of a device for attachment to a garment according to a preferred embodiment of the present invention;

FIG. 2 is a front elevational view of the device of FIG. 1, with a clasp means shown in separated relation from the remainder of the device;

FIG. 2A is a sectional view of the device of FIG. 2 along sight line 2A-2A of FIG. 2;

FIG. 3 is a front perspective view from the top left of the device of FIG. 2, shown in an entry configuration, without the clasp means of the device;

FIG. 3A is an enlarged view of the encircled portion 3A of FIG. 3;

FIG. 3B is an enlarged view of the encircled portion 3B of FIG. 3, shown partly in section;

FIG. 4 is a front perspective view from the top left of a support frame and display panel of the device of FIG. 2, shown in a partially exploded configuration;

FIG. 4A is a sectional view of the support frame of FIG. 4, along sight line 4A-4A of FIG. 4;

FIG. 5 is a front perspective view from the top left of the support frame and display panel of FIG. 4, shown in its partially assembled configuration;

FIG. 6 is a front perspective view from the top left of the device of FIG. 3, shown in a display configuration;

FIG. 7 is an enlarged sectional view of the device of FIG. 6, along sight line 7-7 of FIG. 6;

FIG. 7A is an enlarged view of the encircled portion 7A of FIG. 7;

FIG. 8 is a front right perspective view of the device of FIGS. 1 through 7, shown being attached to a garment; and

FIG. 9 is a view similar to FIG. 8, showing the device of FIGS. 1 through 7 attached to a garment.

### DETAILED DESCRIPTION OF A PREFERRED EMBODIMENT

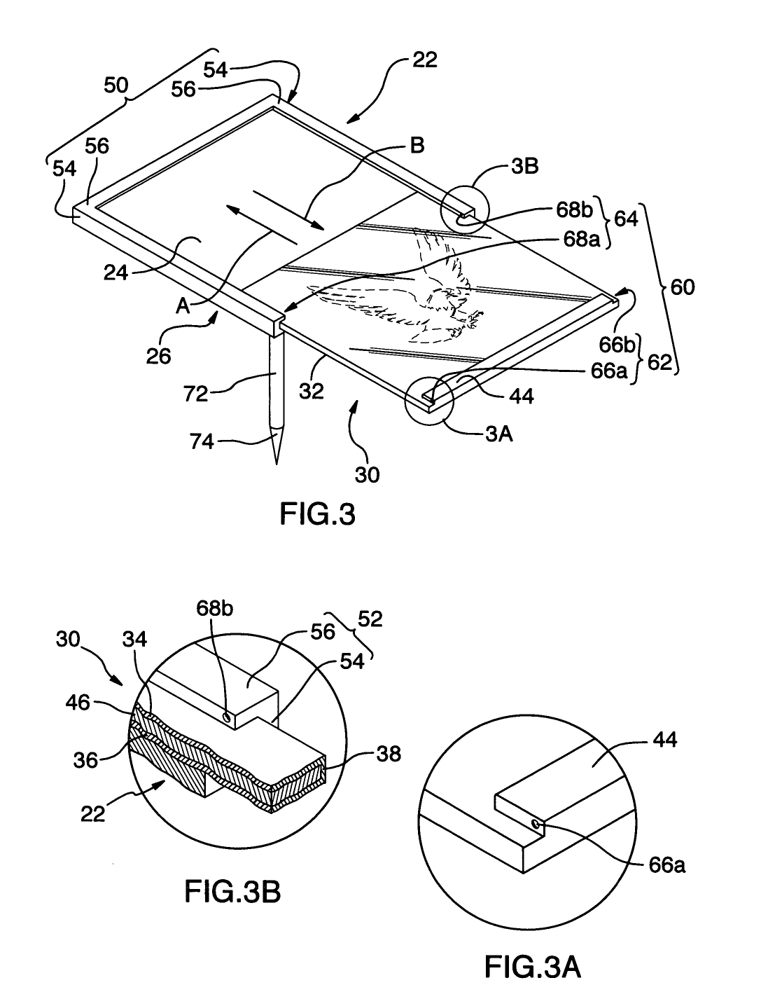

Referring now to the Figures, there will be seen a device 20 for attachment to a garment 10 in accordance with the present invention. As seen in FIG. 3, the device 20 comprises a base member 22, having a substantially planar top surface portion 24 and a bottom surface portion 26. For ease of illustration, the base member 22 is shown as substantially square in shape. One skilled in the art will recognize that the base member 22 could be various other shapes such as, for example, a rectangle, a triangle, or a circle. The selection of a particular shape for the base member 22 is a routine choice to be made by one skilled in the art.

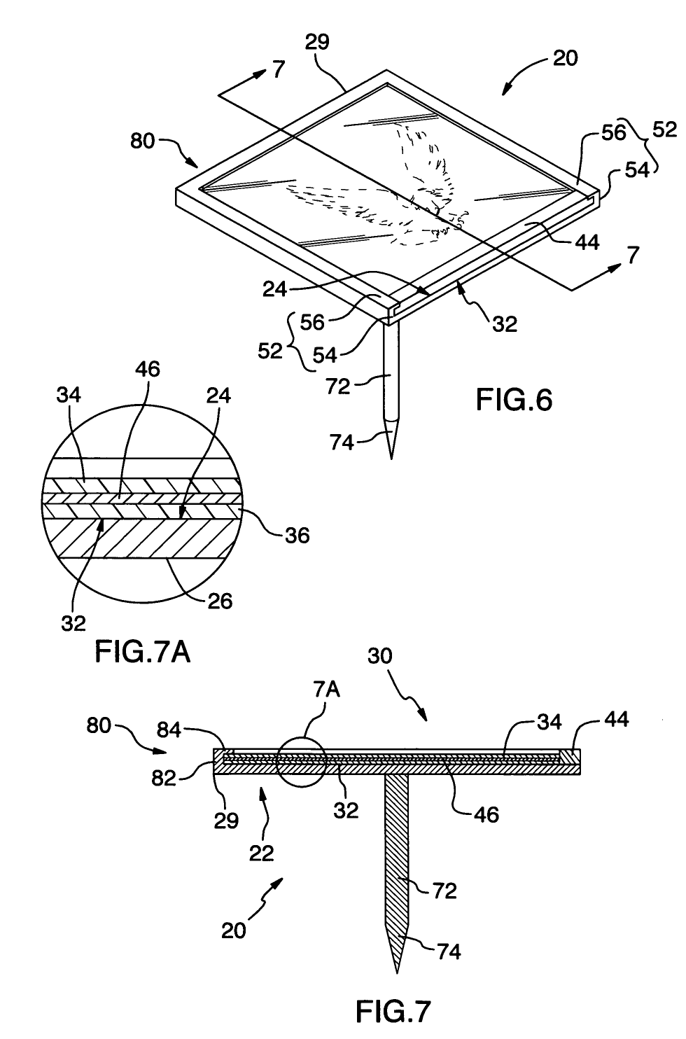

As best seen in FIGS. 3, 4, 4A, and 5, the device 20 further comprises a support frame 30, having a substantially planar bottom surface portion 32. The bottom surface portion 32 is configured so as to be slidably engagable with the top surface portion 24 of the base member 22. The device 20 is in this manner adapted to allow for parallel movement of the support frame 30 relative to the base member 22 in a first slide direction (as generally indicated by reference arrow “A” in FIG. 3), while substantially maintaining contact between the top surface portion 24 and the bottom surface portion 32. Moreover, the device 20 is in an entry configuration when, as seen in FIG. 3, the planar top surface portion 24 is partially overlain by the planar bottom surface portion 32. Further, the device is in a display configuration when, as seen in FIGS. 6, 7, and 7A, the planar top surface portion 24 is substantially fully overlain by the planar bottom surface portion 32, as a result of parallel movement in said first slide direction. For ease of illustration, the base member 22 and support frame 30 are shown in FIG. 6 as both being substantially square when viewed substantially from the top. One skilled in the art will appreciate that the base member 22 and support frame 30 need not necessarily be of substantially the same shape. In some embodiments the base member 22 may be, for example, rectangular and the support frame 30 may be, for example, square. The selection of the particular shape of support frame is, as with the base member 22, a matter of routine design choice for one skilled in the art.

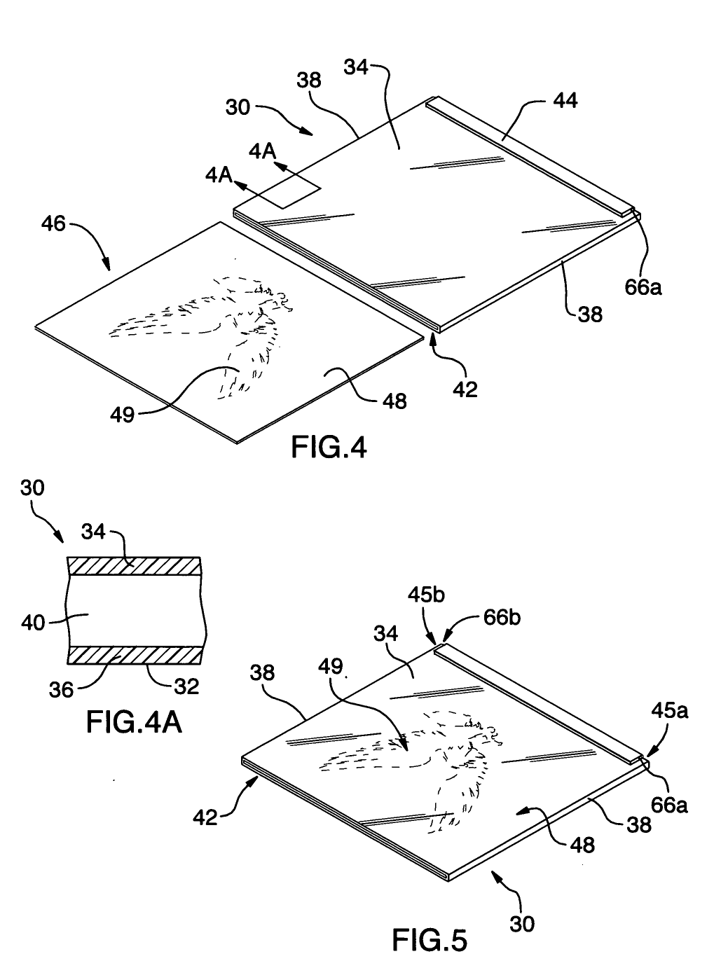

The support frame 30 further comprises a top wall 34, a bottom wall 36 and one or more side walls 38, as seen in FIGS. 3B and 4. Together, the walls 34, 36, 38 define an internal chamber 40 within the support frame 30, as best seen in FIG. 4A.

The device 20 further comprises a display panel 46 having a presentation face 48, preferably with decorative indicia 49 such as, for example, a photographic depiction, as seen in FIGS. 4 and 5, marked thereon. The display panel 46 is preferably slidably insertable into the internal chamber 40 through one or more edge openings 42 (one shown) to same, as seen in FIGS. 4 and 5. For ease of illustration, the internal chamber 40 is shown in the Figures as being of substantially the same geometric shape as the support frame 30. One skilled in the art will appreciate that the internal chamber 40 and support frame 30 need not necessarily be so similarly shaped. In some embodiments of the present invention, the internal chamber 40 may be, for example, substantially rectangular in shape and the support frame 30 may be, for example, substantially square, or vice versa. The presentation face 48 is upwardly directed so as to be visible through the top wall 34 of the support frame 30 when the display panel 46 is fully inserted into the internal chamber 40, to reach a partially assembled configuration, as seen in FIG. 5. One skilled in the art will appreciate that the display panel 46 may be coated in plastic or the like to protect against any exposure to, for example, rain or snow. One skilled in the art will further appreciate that the display panel 46 and/or the top wall 34 could themselves be ornamented and/or decoratively shaped or etched (not shown), in addition to any decorative indicia 49 which may or may not be marked on the presentation face 48.

The top wall 34 of the support frame 30 is preferably substantially transparent, as shown in the Figures, but need not necessarily be so, as some embodiments of the present invention may include apertures (not shown) defined in an otherwise opaque top wall 34. Such apertures (not shown) would allow for viewing of the presentation face 48 of the display panel 46 therethrough. The bottom wall 36 and side walls 38 may also, but need not necessarily, each be substantially transparent, as shown in the Figures.

The device further comprises one or more retainment means 50 mounted on the base member 22, as seen in FIG. 3. The retainment means 50 cooperates with the support frame 30 to retain the top surface portion 24 of the base member 22, and the bottom surface 32 of the support frame 30, in intimate contacted relation with one another during parallel movement in said first slide direction, or in a second slide direction (as generally indicated by reference arrow “B” in FIG. 3) opposite to the first slide direction. The retainment means 50 preferably comprises two inverted L-shaped track members 52, each having a side rail portion 54 and a top rail portion 56. The L-shaped track members 52 are each mounted atop the base member 22 adjacent respective opposed edges 28a, 28b thereof, as seen in FIG. 2. The L-shaped track members 52 are mounted atop the base member such that they are in opposed parallel relation to one another, as seen in FIG. 3. The retainment means 50 is preferably, but not necessarily, mounted on the base member 22 such that the respective L-shape track members 52, and more specifically, the side rail portions 54 of same, are flush with respective ones of the adjacent edges 28a, 28b at which each side rail portion 54 is located, as seen in FIG. 2. Each side rail portion 54 is adapted to be contactable with the support frame 30, in order to limit horizontal travel thereof, in directions transverse to the first slide direction, which is indicated by reference arrow “A” of FIG. 3. Each top rail portion 56 is oriented substantially transverse to a respective one of the side rail portions 54, as seen in FIGS. 3 and 3B, so as to overlie the support frame 30 in contactable relation therewith, thereby to limit vertical travel of the support frame. With this arrangement, parallel movement of the support frame 30 relative to the base member 22 in the first and second slide directions is not substantially impeded by the retainment means 50. While depicted in the preferred embodiment as being L-shaped, one skilled in the art will recognize that the retainment means 50 need not necessarily be so shaped in all embodiments of the present invention. One skilled in the art will further recognize that the retainment means 50 could be of any suitable shape such that, in use, it is capable of limiting horizontal and vertical travel of the support frame 30 in directions transverse to the first slide direction, in the same general manner as described hereinabove.

The device 20 additionally comprises a stop means 80, mounted atop the base member 22 adjacent a third edge 29 of same, as seen in FIG. 7. As seen in FIG. 6, the stop means 80 is mounted such that it is substantially normal to the L-shaped track members 52 of the retainment means 50. The stop means 80 preferably comprises an edge rail 82 adapted to contact the support frame 30, as seen in FIG. 7, when the device 20 is in the display configuration, so as to limit further movement of the support frame 30 in the first slide direction. The stop means 80 further optionally comprises an upper rail 84, as seen in FIG. 7, oriented substantially transverse to the end rail 84 so as to overlie, and thereby limit vertical travel of, the support frame 30 when the device 20 is in the display configuration. While depicted in the preferred embodiment as being L-shaped and of similar cross-sectional profile to the retainment means 50, one skilled in the art will recognize that the stop means 80 need not necessarily be so shaped or profiled. As such, one skilled in the art will further recognize that the stop means 80 could be of any shape, so long as it is capable of limiting further parallel movement in the first slide direction, of the support frame 30, when the device 20 is in the display configuration. Further, limitation of vertical travel of the support frame 30 by the stop means 80 while desirable (as in the preferred embodiment illustrated), is not essential.

It will be appreciated by one skilled in the art that substantially all of the components of the retainment means 50, the stop means 80, and the base member 22, may preferably be formed from a single workpiece. Alternatively, the components of the retainment means 50, stop means 80, and the base member 22 may each be constructed from two or more materials and/or securely affixed to each other by affixation means such as, for example, an adhesive or the like. The particular means of affixation is a matter of routine design choice to be made by one skilled in the art based on, for example, the particular materials to be attached to one another.

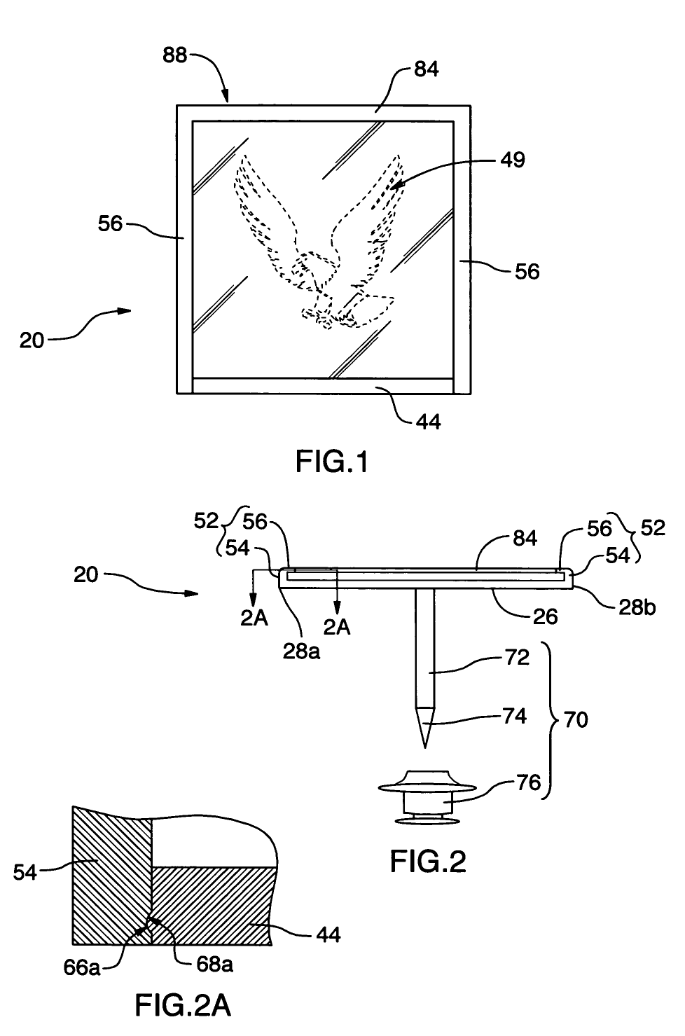

The support frame 30 further comprises a peripheral lip portion 44, seen in FIGS. 3, 4, 5, and 7. The peripheral lip portion 44 is shaped and dimensioned so as to collectively define, together with the upper rail 84 and the top rail portions 56, at the display configuration, a contiguous border 88 substantially framing the presentation face 48, as seen in FIG. 1.

It will be appreciated by one skilled in the art that the peripheral lip portion 44 and the walls 34, 36, 38 may preferably be integrally formed as one. Alternatively, it will be further appreciated that the peripheral lip portion 44, top wall 34, bottom wall 36 and side walls 38 may each be formed as two or more separate structures (from the same or different materials) and/or securely affixed to one another by means of an adhesive or other suitable means of affixation. The particular means of affixation is a matter of routine choice for one skilled in the art, which choice may be made based upon, for example, the materials making up the particular structures to be attached to each other. For example, the top wall 34 may be constructed from a clear plastic material, while the remainder of the support frame 30 (i.e. The bottom wall 36, the side walls 38, and the peripheral lip portion 44), may be made from, for example, coloured plastic or metal.

The device 20 further comprises a catchment means 60 having cooperating portions 62, 64 mounted on each of the retainment means 50 and the support frame 30, as seen in FIG. 3. The first cooperating portion 62 of the catchment means 60 preferably comprises two male members 66a, 66b mounted on opposed ends of the peripheral lip portion 44, as seen in FIGS. 3 and 3A. The first male member 66a is located on a first end 45a of the peripheral lip portion 44, while the second male member 66b is located at an opposite end 45b, as seen in FIG. 5. The second cooperating portion 64 of the catchment means 60 comprises two substantially concave detents 68a, 68b, defined on respective ones of the L-shaped track members 52 of the retainment means 50, as seen in FIGS. 3 and 3B. The cooperating portions 62, 64 frictionally engage one another, as shown by the engagement of the first male member 66a and its mate detent 68a in FIG. 2A, when the device 20 is in the display configuration, and thereby serve to hold the support frame 30 against parallel movement in the second slide direction. The detents 68a, 68b are shown as located on the top rail portions 56 of the retainment means 50, but need not necessarily be so positioned. One skilled in the art will appreciate that the positioning of the cooperating portions 62, 64 is limited only in that mating pairs of same must substantially engage one other, as will be appreciated from a consideration of FIG. 2A, when the device 20 is in the display configuration. As such, one skilled in the art will further appreciate that the respective locations of the male members 66a, 66b, shown as being located on the top rail portions 56, and their respective complimentary detents 68a, 68b, shown as being defined on the peripheral lip portion 44, could be reversed in other embodiments of the present invention.

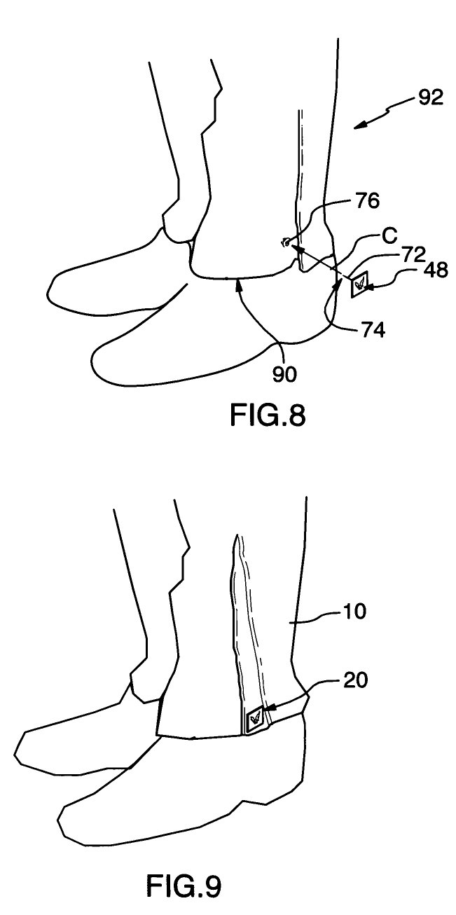

As seen in FIG. 2, the device 20 additionally comprises an attachment means 70 which comprises a stem portion 72 attached to, and extending away from, the bottom surface 26 of the base member 22. The stem portion 72 terminates in a substantially pointed end portion 74, as seen in FIG. 2. The attachment means 70, as illustrated, further comprises a clasp means 76 adapted to removably grip the stem portion 72, thereby to hold a section of the garment 10 between the bottom surface 26 and the clasp means 76, as will be appreciated from a consideration of FIGS. 8 and 9. In the preferred embodiment, the clasp means 76 is a prior art clasp 76, with a substantially central cylindrical opening which is adapted to receive the terminal end portion 74 and at least part of the stem portion 72 therein and to secure same by means of clamping friction, as is well known in the art. One skilled in the art will recognize that the clasp means 76 could be any means capable of securing the device 20 of the present invention to a garment. Many such devices including, for example, hinged pins such as those commonly extending from the stems of, for example, cufflinks (not shown), are well-known in the art.

It will also be appreciated by one skilled in the art that substantially all of the components described hereinabove may, on their own or in combination with one another, be constructed from one or more materials selected from the group comprising: precious, semi-precious, and other metal materials; carbon fiber, ceramic, rubber, plastic, and the like.

In use, the device 20 of the present invention may be attached at any location selected by a user on a garment 10, provided space permits. Such locations include, but are not limited to, for example, at or about the hem of a pair of pants, as seen in FIGS. 8 and 9. The location may be chosen such that the device 20, when attached to the garment 10, serves to retain in position a hem or cuff of same. A user may choose a desired display panel 46 and presentation face 48, with or without any desired decorative indicia 49 already marked thereon. Once chosen, the desired display panel 46 may be inserted, by the user, into the internal chamber 40 of the support frame 30 through the edge opening 42 described hereinabove, to reach the partially assembled configuration shown in FIG. 5. Once the desired display panel is within the internal chamber 40, the user may then slidingly engage the support frame 30 with the base member 22, such that the device 20 is then substantially in the entry configuration, as seen in FIG. 3. The support frame 30 can then be slid by the user in the first slide direction, while restrained against horizontal and vertical movement transverse to same by the retainment means 50. Upon reaching the display configuration, seen in FIG. 6, the retainment means 50, stop means and, once engaged, the catchment means 60, maintain the position of the support frame 30 relative to the base member 22, as described hereinabove. The presentation face 48 and decorative indicia 49 thereon are then viewable through the top wall 34 of the support frame 30, as seen in FIG. 6. In such a display configuration, the cooperating portions 62, 64 of the catchment means 60 substantially fully engage one another, as seen in FIG. 2A and described hereinabove, as a result of application by the user of sufficient force on the support frame 30 in the first slide direction.

To affix the device 20 to the garment 10, as seen in FIG. 8, the user positions the clasp means on an interior side 90 of the garment 10 and the remainder of the device 20, in the display configuration, on an exterior side 92 of the garment 10. The user may then attach the device 20 to the garment 10 by inserting the end portion 74 and at least part of the stem portion 72, in an insertion direction (as generally indicated by reference arrow “C” in FIG. 8) through the garment 10 itself, or one or more apertures therethrough, and securing the clasp means 76 to the stem portion 72, as described hereinabove, on the interior side 90 of the garment 10, thereby to attach the device 20 to the garment 10, as seen in FIG. 9.

To remove the device 20 from the garment 10, a user may perform, in substantially the reverse order, tasks substantially the opposite of those discussed hereinabove with respect to attachment of the device 20 to the garment 10. It should be noted that the display panel 46 may be replaced without having to remove the device 20 from the garment 10; however, a user may remove the device 20 from the garment 10 in the manner described above in order to replace the display panel 46, if he or she so chooses. To switch display panels 46, the user may first apply a force in the second slide direction (of reference arrow “B” in FIG. 3), to the support frame 30 that is substantially equal in magnitude and substantially opposite in direction to the force described hereinabove with respect to engagement of the cooperating portions 62, 64 of the catchment means 60, in order to disengage same. The support frame 30 may then be removed from the base member 22 by sliding the support frame 30 in the second slide direction, until the base member 22 and support frame 30 no longer contact each other, or at least until the edge openings 42 are sufficiently accessible so as to allow removal of the display panel 46 from the internal chamber 40 by the user. The user may then remove the current display panel 46 and replace it with another one of his or her choice.

Other modifications and alterations may be used in the design and manufacture of other non-illustrated embodiments according to the present invention without departing from the spirit and scope of the invention, which is limited only by the accompanying claims. For example, the display panel 46 may be encapsulated by the internal chamber 40 of the support frame 30 in a manner other than as a result of insertion through the edge openings 42. The top wall 34 and the bottom wall 36 may together form a hinge at one end of the support frame 30 such that the display panel 46 may then be positioned between the side walls 38 and adjacent one of the top wall 34 and bottom wall 36, after the top wall 34 and/or bottom wall 36 have been moved about the hinge to an open configuration. The display panel 46 would, with this arrangement, be enclosed within the internal chamber 40 when it is reformed by moving the top wall 34 and/or bottom wall 36 about the hinge to a closed configuration, suitable for insertion into the base member 22.

By way of additional example, some embodiments of the device 20 of the present invention could be constructed without the upper rail 84 of the stop means 80.

Further, some embodiments of the present invention may include display panels 46 shaped and dimensioned such that more than one of same can be slidably inserted into the internal chamber 40 so as to be displayed at the same time.

Each display panel 46 may, in some embodiments of the present invention, be configured so as to have more than one presentation face 48, with or without decorative indicia 49 marked thereon. The user could simply remove the display panel 46 from the internal chamber 40 as described hereinabove and replace it in such a position that a different presentation face 48 would be viewable once the dislplay panel 46 was fully inserted into the internal chamber 40, as described hereinabove.

One skilled in the art will appreciate that the retainment means 50 and stop means 80 could each alternatively be mounted on the support frame 30, rather than on the base member 22 as described hereinabove.

In view of the fact that the preceding are but a few examples of other modifications and alterations which may be used in the design and manufacture of other embodiments according to the present invention, it should, perhaps, be once again specifically stated that the spirit and scope of the invention is limited only by the accompanying claims.

I claim:

1. A device for attachment to a garment comprising:
(a) a base member having a substantially planar top surface portion and a bottom surface portion;
(b) a support frame having a substantially planar bottom surface portion slidably engagable with said planar top surface portion of the base member upon parallel movement of said support frame relative to said base member in a first slide direction from an entry configuration wherein said planar top surface portion is partially overlain by said planar bottom surface portion to a display configuration wherein said planar top surface portion is substantially fully overlain by said planar bottom surface portion;
(c) one or more retainment means mounted on said base member for cooperation with said support frame to retain said planar top surface portion of the base member and the planar bottom surface of said support frame in intimate contacted relation with one another during said parallel movement in said first slide direction;
(d) a catchment means having cooperating portions mounted on each of said retainment means and said support frame to engage one another at said display configuration to hold said support frame against parallel movement in a second slide direction opposite to said first slide direction; and,
(e) an attachment means affixed to said bottom surface portion of said base member, for removably securing said device to said garment.

2. The device according to claim 1, wherein said support frame has a top wall, a bottom wall and one or more side walls together defining an internal chamber, with one or more edge openings providing access to said internal chamber, and with the device additionally comprising a display panel slidably insertable into said internal chamber through said one or more edge openings.

3. The device according to claim 2, wherein said display panel has a presentation face with decorative indicia marked thereon, said presentation face being upwardly directed so as to be visible through said top wall of the support frame when the display panel is fully inserted into the internal chamber.

4. The device according to claim 3, wherein said top wall of said support frame is substantially transparent.

5. The device according to claim 4, wherein said retainment means comprises two inverted L-shaped track members, mounted atop said base member adjacent opposed edges thereof in parallel relation to one another, each comprising:
(a) a side rail portion adapted to be contactable with said support frame to limit horizontal travel thereof in directions transverse to said first and said second slide directions; and
(b) a top rail portion oriented substantially transverse to said side rail portion so as to overlie said support frame in contactable relation, thereby to limit vertical travel thereof.

6. The device according to claim 5, wherein a stop means is mounted atop said base member adjacent a third edge thereof in substantially transverse relation to said track members, and adapted so as to be contactable with said support frame at said display configuration so as to limit further parallel movement thereof in said first slide direction.

7. The device according to claim 6, wherein said stop means comprises an edge rail adapted to contact said support frame at said display configuration to limit as aforesaid further parallel movement of the support frame in said first slide direction.

8. The device according to claim 7, wherein said support frame further comprises a peripheral lip portion.

9. The device according to claim 8, further comprising an upper rail oriented substantially transverse to said edge rail so as to overlie said support frame at said display configuration to limit vertical travel thereof, wherein said peripheral lip portion is shaped and dimensioned so as to collectively define with said top rail portions of said retainment means and said upper rail at said display configuration, a contiguous border substantially framing said presentation face.

10. The device according to claim 9, wherein a first one of said cooperating portions of said catchment means comprises one or more male members mounted on said peripheral lip portion.

12. The device according to claim 11, wherein a second one of said cooperating portions of said catchment means comprises one or more detents defined on respective ones of the L-shaped track members of the retainment means.

13. The device according to claim 12, wherein said attachment means comprises a stem portion attached to and extending away from said bottom surface of said base member and terminating in a substantially pointed end portion.

14. The device according to claim 13, wherein said attachment means further comprises a clasp means adapted to removably grip said stem portion, thereby to hold a section of said garment therebetween.

15. The device according to claim 14, wherein said decorative indicia is a photographic depiction.
